(19) United States
(12) Patent Application Publication
(10) Pub. No.: US 2018/0318802 A1
(43) Pub. Date: Nov. 8, 2018

(54) CATALYTIC REACTION

(71) Applicant: James Dorman, Baton Rouge, LA (US)

(72) Inventor: James Dorman, Baton Rouge, LA (US)

(21) Appl. No.: 15/970,659

(22) Filed: May 3, 2018

Related U.S. Application Data
(60) Provisional application No. 62/500,860, filed on May 3, 2017.

(51) Int. Cl. B01J 23/745; B01J 8/02; B01J 19/00; B01J 8/06

(52) U.S. Cl. CPC B01J 23/745; B01J 8/0292; C07B 33/00; B01J 8/067; B01J 19/0013

(57) ABSTRACT

Reaction methods are disclosed including induction catalysts. Such reactions may involve heating a catalyst by inductive heating; contacting the catalyst with a composition such that a reaction occurs and removing a reaction product. Example reactions include catalysts with ferrimagnetic metal oxide material and reactions involving organic reactants.

Catalytic reaction methods and reactors described herein may be used in the catalytic reaction of organic compositions and may provide significant gains in energy efficiency for such reactions. In particular, such catalytic reactions may be useful in the dehydrogenation of hydrocarbons.

### BRIEF DESCRIPTION OF THE DRAWINGS

FIG. 1 shows a reactor setup.

FIG. 2 shows a cut away of a reactor tube.

FIG. 3 shows a partial cut away of a catalyst particle.

### DETAILED DESCRIPTION

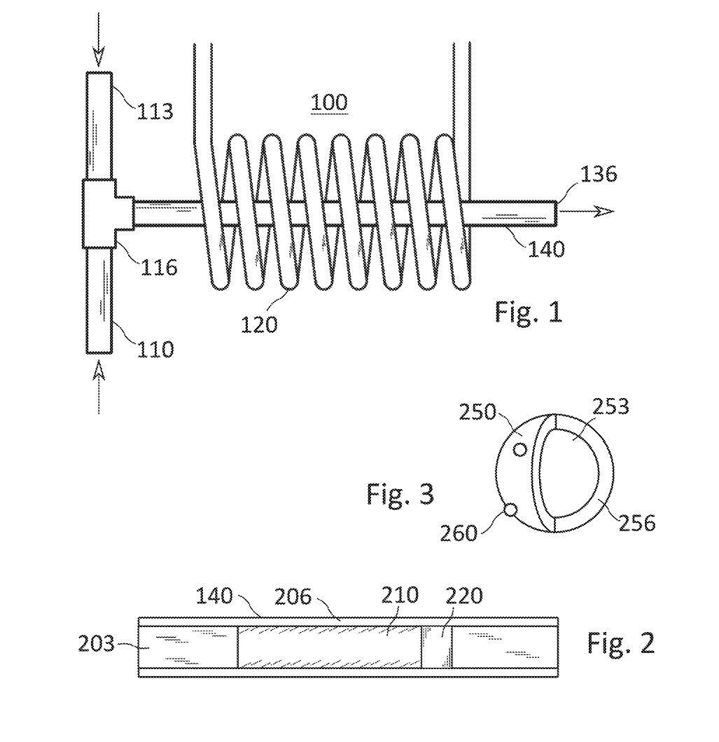

Referring to FIG. 1, Reactor 100 includes Oxidizer supply line 110, Feed gas line 113, T fitting 116, Induction heater coil 120, Reaction product outlet 136 and Reaction tube 140. Oxygen or other gasses used to regenerate catalyst may be supplied from Oxidizer supply line 110. Such gases may be selected from oxygen, carbon dioxide or combinations thereof. Other gases capable of regenerating Fe₂O₃ to Fe₃O₄ may be used as well. Regeneration would typically happen between reaction runs to restore the effectiveness of the catalyst. For that reason, the reactor setup depicted in FIG. 1 would typically supply gas from only one of Oxidizer supply line 110 and Feed gas line 113 at a time. Feed gas line 113 may deliver a metered supply of organic molecules and/or hydrocarbons through T fitting 116 to pass through Reaction tube 140 inside of Induction heater coil 120. Both Oxidizer supply line 110 and Feed gas line 113 may have mass flow control systems to control the delivery of gas to the reactor. The reactor may be configured to deliver a single reactant or more than one reactant with control and metering of such delivery. The reaction of the hydrocarbons takes place within Reaction tube 140 in the area heated by Induction heater coil 120 and the reaction products leave through Reaction product outlet 136.

FIG. 2 depicts the interior of Reaction tube 140 including Reaction tube inner surface 203, Reaction tube wall 206, Packed catalyst 210 and Glass wool packing 220. Reaction tube 140 is open to T fitting 116 and Reaction product outlet 136. (both shown in FIG. 1)

FIG. 2 is arranged to depict the configuration of Packed catalyst 210 and Glass wool packing 220 within Reaction tube wall 206. Glass wool packing 220 holds Packed catalyst 210 in position so that the catalyst can be influenced by inductive heating. The packing of the catalyst at Packed catalyst 210 in the figure may be a loose packing to permit the flow of gases through the catalyst.

FIG. 3 depicts Catalyst particle 250, shown in partially cut away form, which is predominantly made up of Catalyst particle core 253, Catalyst particle outer shell 256, and Decorations 260. Catalyst particle core 253 is surrounded by Catalyst particle outer shell 256 which may have a variety of Decorations 260 distributed around the outer surface of Catalyst particle outer shell 256. The catalyst particles depicted in FIG. 2 or variations therefrom may be situated in Reaction tube 140 as the Packed catalyst 210.

In one example, the Catalyst particle core 253 may be Fe₃O₄, the Catalyst particle outer shell 256 may be Mn₃O₄ and Decorations 260 may be platinum. In another example, the Catalyst particle core 253 may be Mn₃O₄ and the Catalyst particle outer shell 256 may be Fe₃O₄ and Decorations 260 may be platinum. The combinations of catalytic materials that may be used can have a significant variety. Examples of such materials and material combinations may include one or more materials that respond to inductive heating. Table 1 below lists a variety of examples of potential catalyst configurations.

TABLE 1

| | Core | Shell | Decoration |
|---|---|---|---|
| Example A | Fe₃O₄ | Fe₃O₄ | None |
| Example B | Fe₃O₄ | Fe₃O₄ | Pt |
| Example C | Fe₃O₄ | Fe₃O₄ | Pd |
| Example D | Fe₃O₄ | Fe₃O₄ | Au |
| Example E | Fe₃O₄ | Mn₃O₄ | None |
| Example F | Fe₃O₄ | Mn₃O₄ | Pt |
| Example G | Fe₃O₄ | Mn₃O₄ | Pd |
| Example H | Fe₃O₄ | Mn₃O₄ | Au |
| Example I | Mn₃O₄ | Fe₃O₄ | None |
| Example J | Mn₃O₄ | Fe₃O₄ | Pt |
| Example K | Mn₃O₄ | Fe₃O₄ | Pd |
| Example L | Mn₃O₄ | Fe₃O₄ | Au |
| Example M | Fe₃O₄ | Co₃O₄ | None |
| Example N | Fe₃O₄ | Co₃O₄ | Pt |
| Example O | Fe₃O₄ | Co₃O₄ | Pd |
| Example P | Fe₃O₄ | Co₃O₄ | Au |
| Example Q | Co₃O₄ | Fe₃O₄ | None |
| Example R | Co₃O₄ | Fe₃O₄ | Pt |
| Example S | Co₃O₄ | Fe₃O₄ | Pd |
| Example T | Co₃O₄ | Fe₃O₄ | Au |

As described in Table 1, catalyst particles having Fe₃O₄ as both the core and the shell are simply continuous Fe₃O₄ particles. It is further contemplated that the catalyst particles may be in a variety of shapes including spheres, cubes, plates, pyramids and other forms. Further, the catalyst particles may be conformal, having a relatively uniform geometry, or may be non-conformal, allowing for a large number of points of metal-metal interface as potential reaction sites. Other catalyst particles having geometric forms demonstrating particular suitability for high-efficiency inductive heating may also be used. Catalyst particles may be between 20 nm and 100 μm. The catalytic particles may be weak magnets or soft magnets. The catalytic particles may contain ferrimagnetic materials or ferromagnetic materials. The catalytic particles may be characterized as ferrimagnetic, ferromagnetic or superparamagnetic. Magnetic particles with stronger magnetic fields than the Fe₃O₄ particles may have smaller particle sizes. Further, nickel and other catalytic materials may be used in the place of the non-superparamagnetic catalytic material described in the Table 1 and may be used in other described catalytic materials.

A material's suitability to serve as the material that responds to inductive heating within the catalyst may be characterized by the specific loss power of the material within a 10 kW inductive coil heater operating at 280 kHz. The specific loss power of the material that responds to inductive heating within the catalyst under such circumstances may be greater than 50 W/g. In many cases the specific loss power of the material that responds to inductive heating within the catalyst under such circumstances may be greater than 500 W/g. In many cases the specific loss power of the material that responds to inductive heating within the catalyst under such circumstances may be greater than 2000 W/g.

The present reactor may be configured such that controlled heating of the surface of nanoparticles within the reactor is achieved. Ferrimagnetic and superparamagnetic materials within the nanoparticles respond to the inductive heating and heat the catalyst. Any one of iron oxide, manganese oxide and cobalt oxide or combinations thereof may be used as the heating material within the catalyst. The examples of Table 1 use Fe₃O₄ as the material that responds to inductive heating within the catalyst. However, the examples of Table 1 may be modified such that any of iron oxide, manganese oxide and cobalt oxide or combinations thereof may be used as the material that responds to inductive heating within the catalyst. Nickel oxide may also be used as the magnetic material. The presence of such materials within the catalyst allows for precise temperature control by controlling factors such as frequency and pulse length of the induction coil. Fe₃O₄ may serve as the active catalyst in the dehydrogenation of hydrocarbons. Reaction temperatures in the reactor may be significantly below temperatures conventionally associated with processing hydrocarbons. The temperature of the reactor may be below 300° C. Further, the reactor feed may be less than 250° C. and in certain cases may be less than 100° C. By controlling the pulsed stimulation of the inductive coil, specific hydrocarbon conversions or conversions of other organic molecules may be selected and fouling and or degradation of the catalyst may be avoided or delayed. Pulses of power to the inductive coil may be used to raise the temperature of the catalyst for a short period of time followed by a period of no heating and such pulsing may be used to select for specific reaction products and to avoid coking of the catalyst. Control of the pulsed stimulation of the inductive coil may be varied for different pulsing patterns and different pulsing frequencies. The control of the stimulation of the inductive coil may be regulated for the selection of particular reaction products.

Reaction tube 140 may, for example, be one of many such similar reaction tubes bundled or otherwise configured to pass through the inductive heating coil. The reactor may be scaled up to larger commercial embodiments by a variety of methods including multiplying the number of reaction tubes within an induction coil, increasing the total number of induction coil reactor systems or both. Reaction tube 140 may, for example, be a ¼ inch quartz tube. Variations in the size of the individual reactor tube are also contemplated.

The reactor may be insulated in various ways including the use of glass tubes, rubber insulation and other insulating materials that do not interfere with the inductive heating. Further, the coil may be water cooled and components may be air cooled.

The feed gas introduced through Feed gas line 113 may for example be methane, ethane, propane or mixtures thereof. Other examples of the feed gas may include any hydrocarbon or other organic molecules that are gaseous at temperatures below 200° C. Feed rates may be optimized based on the feed gas, the particular reaction product selected for production, economic and other considerations. The reactor may have substantial utility for the dehydrogenation of hydrocarbons and various other reactions involving organic reactants. The reactor may have further utility for endothermic reactions generally and may have particular utility for endothermic reactions where high temperatures would otherwise be required.

Reaction methods described herein may, for example, comprise heating a catalyst by inductive heating; contacting the catalyst with a composition and removing a reaction product from a space encompassing the catalyst such that the catalyst comprises a superparamagnetic metal oxide material; the superparamagnetic metal oxide material makes up at least 20% of the catalyst by weight; the composition comprises a quantity of saturated hydrocarbon; the reaction product comprises a quantity of unsaturated hydrocarbon and the composition is less than 300° C. prior to contacting the composition with the catalyst. In a related example, the catalyst may comprise particles between 20 nm and 100 μm. In a related example, the catalyst may comprise Fe₃O₄. In a related example, the reaction method may further comprise regenerating the catalyst by contacting the catalyst with an oxidizer. In a related example, the contacting of the catalyst with the composition may take place within an insulated reactor. In a related example, the contacting of the catalyst with the composition may result in an exothermic reaction.

Reaction methods described herein may, for example, comprise heating a catalyst by inductive heating; contacting the catalyst with a composition such that a reaction occurs and removing a reaction product from a space encompassing the catalyst such that the catalyst comprises a superparamagnetic metal oxide material; such that the superparamagnetic metal oxide material makes up at least 20% of the catalyst by weight; such that the composition comprises a quantity of organic molecules without double bonds; such that the reaction product comprises a quantity of organic molecules with double bonds and such that the superparamagnetic metal oxide material has a specific loss power greater than 50 W/g. In a related example, the composition may be less than 300° C. prior to contacting the composition with the catalyst. In a related example, the reaction method may further comprise regenerating the catalyst by contacting the catalyst with an oxidizer. In a related example, the inductive heating may comprise pulses of inductive heat. In a related example, the contacting of the catalyst with the composition may take place within an insulated reactor. In a related example, the contacting of the catalyst with the composition may result in an exothermic reaction. In a related example, the contacting of the catalyst with the composition may result in a dehydrogenation reaction. In a related example, the contacting of the catalyst with the composition may result in an exothermic dehydrogenation reaction.

Reaction methods described herein may, for example, comprise heating a catalyst by inductive heating; contacting the catalyst with an organic composition such that a reaction occurs and removing a reaction product from a space encompassing the catalyst such that the catalyst comprises a ferrimagnetic metal oxide material; the ferrimagnetic metal oxide material makes up at least 20% of the catalyst by weight; wherein the reaction product comprises a quantity of organic molecules and the ferrimagnetic metal oxide material has a specific loss power greater than 50 W/g.

The above-described embodiments have several independently useful individual features that have particular utility when used in combination with one another including combinations of features from embodiments described separately. There are, of course, other alternate embodiments which are obvious from the foregoing descriptions, which are intended to be included within the scope of the present application.

What is claimed is:

1. A reaction method comprising:
a. heating a catalyst by inductive heating;
b. contacting the catalyst with an organic composition such that a reaction occurs and
c. removing a reaction product from a space encompassing the catalyst;
d. wherein the catalyst comprises a ferrimagnetic metal oxide material;
e. wherein the ferrimagnetic metal oxide material makes up at least 20% of the catalyst by weight;
f. wherein the reaction product comprises a quantity of organic molecules and
g. wherein the ferrimagnetic metal oxide material has a specific loss power greater than 50 W/g.

2. The reaction method of claim 1 wherein the catalyst comprises particles between 20 nm and 100 μm.

3. The reaction method of claim 1 wherein the catalyst comprises Fe₃O₄.

4. The reaction method of claim 7 wherein the organic composition is less than 300° C. prior to contacting the organic composition with the catalyst.

5. The reaction method of claim 7 further comprising regenerating the catalyst by contacting the catalyst with an oxidizer.

6. The reaction method of claim 7 wherein the inductive heating comprises pulses of inductive heat.

7. The reaction method of claim 7 wherein the contacting of the catalyst with the organic composition takes place within an insulated reactor.

8. The reaction method of claim 7 wherein the contacting of the catalyst with the organic composition results in an exothermic reaction.

9. The reaction method of claim 1 wherein the catalyst comprises a superparamagnetic material.

10. The reaction method of claim 7:
a. further comprising regenerating the catalyst by contacting the catalyst with an oxidizer;
b. wherein the organic composition is less than 300° C. prior to contacting the organic composition with the catalyst;
c. wherein the inductive heating comprises pulses of inductive heat;
d. wherein the contacting of the catalyst with the organic composition takes place within an insulated reactor and
e. wherein the contacting of the catalyst with the organic composition results in an exothermic reaction.
